(19) United States
(12) Patent Application Publication
(10) Pub. No.: US 2008/0136168 A1
(43) Pub. Date: Jun. 12, 2008

(54) THREADED UNION NUT AND SLIDING HAMMER FOR ROTATING SAME

(76) Inventors: Tep Ungchusri, The Woodlands, TX (US); William H. Garner, Houston, TX (US); James R. Soltau, Stephenville, TX (US); Alan R. Killingsworth, The Woodlands, TX (US)

Correspondence Address: WILLIAMS, MORGAN & AMERSON, 10333 RICHMOND, SUITE 1100, HOUSTON, TX, 77042, US

(21) Appl. No.: 11/550,686

(22) Filed: Oct. 18, 2006

(51) Int. Cl. F16L 55/00

(52) U.S. Cl. 285/39

(57) ABSTRACT

A threaded union nut is disclosed which includes a body, a threaded opening formed in the body and a web including a plurality of impact openings that are radially offset from a centerline of the threaded opening, wherein the impact openings are adapted to be engaged by a device so as to rotate the threaded union nut. A sliding hammer is also disclosed which includes a guide rod, a structural member coupled to the guide rod and a hammer having an internal bore adapted to receive the guide rod therein. The sliding hammer further includes a flexible cable and a swing handle, wherein the cable is coupled to the hammer and to the swing handle. The hammer is adapted to strike the structural member.

### BACKGROUND OF THE INVENTION

1. Field of the Invention

The present invention is generally related to the field of threaded connectors, and, more particularly, to a union nut and a sliding hammer for rotating the union nut.

2. Description of the Related Art

There are a number of applications in many industries, such as the oil and gas industry, which require the coupling of components to one another by threaded connectors. For example, threaded nuts, caps or other devices may be used to close the end of a pipe, close the outlet of a piece of equipment, or to connect threaded components to one another. FIGS. 1A-1D depict an illustrative wing union nut 10 that is in widespread use in the oil and gas industry. The wing union nut 10 comprises a threaded opening 12 and a plurality of radially extending lugs 14.

Typically, such wing union nuts 10 are tightened or loosened by a person striking one of the lugs 14 with a hammer 15. The effectiveness of such hammer strikes can vary for a variety of reasons. For example, such wing union nuts 10 may be located in places where space restraints make it difficult to accurately and squarely strike the desired lug 14. Additionally, such wing union nuts 10 may be located at places that are difficult and/or dangerous to access, e.g., at elevated locations on an offshore drilling rig.

There are several problems associated with the tightening and loosening of such prior art wing union nuts 10. Even in conditions where such a prior art wing union nut 10 is readily accessible, it is difficult to repeatedly strike the desired lug 14 squarely and solidly. More typically, the lugs 14 are, over time, subjected to many glancing, non-square hammer strikes that can distort the original square shape of the lugs 14. FIG. 1D depicts a wing union nut 10 with such damaged lugs 14. The damage may be reflected in the sloped or rounded sidewalls 16. Such sloped or rounded sidewalls make it even more difficult to avoid a glancing blow when striking such damaged lugs 14 with a hammer. In some cases, as the severity of the damage to the lugs 14 increases, the effective radius (relative to the centerline of the wing union nut 10) where the strike occurs is reduced, thereby reducing the torque applied to the wing union nut 10. Over time, the lugs 14 may become so disfigured that the wing union nut 10 may need to be replaced or the rounded sidewalls 16 of the lugs 14 may be subjected to a grinding process to reduce the amount of the taper, i.e., the grinding is performed in an attempt to make the sidewalls 16 more vertical or square.

The tightening and loosening of the prior art wing union nut 10 using a traditional hammer 15 presents various safety concerns. As indicated previously, relatively heavy sledge hammers 15 are typically employed to tighten or loosen the wing union nut 10. Under the best of conditions, e.g., flat ground, there may be many glancing blows and/or attempts that completely miss the target lug 14. Such actions may be problematic in that the hammer 15 may strike other equipment, other personnel and/or injure the person swinging the hammer 15.

The present invention is directed to an apparatus and methods for solving, or at least reducing the effects of, some or all of the aforementioned problems.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one illustrative embodiment, a threaded union nut is disclosed which comprises a body, a threaded opening formed in the body and a web comprising a plurality of impact openings that are radially offset from a centerline of the threaded opening, wherein the impact openings are adapted to be engaged by a device so as to rotate the threaded union nut.

In another illustrative embodiment, a sliding hammer is disclosed which comprises a guide rod, a structural member coupled to the guide rod and a hammer having an internal bore adapted to receive the guide rod therein. The sliding hammer further comprises a flexible cable and a swing handle, wherein the cable is coupled to the hammer and to the swing handle. The hammer is adapted to strike the structural member.

### BRIEF DESCRIPTION OF THE DRAWINGS

The invention may be understood by reference to the following description taken in conjunction with the accompanying drawings, in which like reference numerals identify like elements, and in which:

FIGS. 1A-1D depict an illustrative prior art wing union nut and a method of tightening or loosening such a device;

FIGS. 2A-2B are, respectively, exploded and coupled views of one illustrative embodiment of a threaded union nut and slide hammer in accordance with the present invention;

FIGS. 3A-3B depict one illustrative embodiment of a threaded union nut in accordance with the present invention;

FIGS. 4A-4D depict another illustrative embodiment of a threaded union nut in accordance with the present invention;

FIGS. 5A-5H depict other illustrative embodiments of a threaded union nut in accordance with the present invention;

FIGS. 6A-6G depict various aspects of the yoke and hammer of the sliding hammer of the present invention;

FIG. 7 is a cross-sectional view of an illustrative flexible cable and swing handle that may be employed with the present invention;

FIGS. 8A-8C are views of an illustrative embodiment of a sliding hammer in accordance with the present invention with an illustrative protective cover;

FIG. 9 is a view of an alternative embodiment of a sliding hammer that may be employed with the present invention; and

FIGS. 10A-10C are views of an illustrative hand tool that may be employed to rotate the threaded union nuts of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

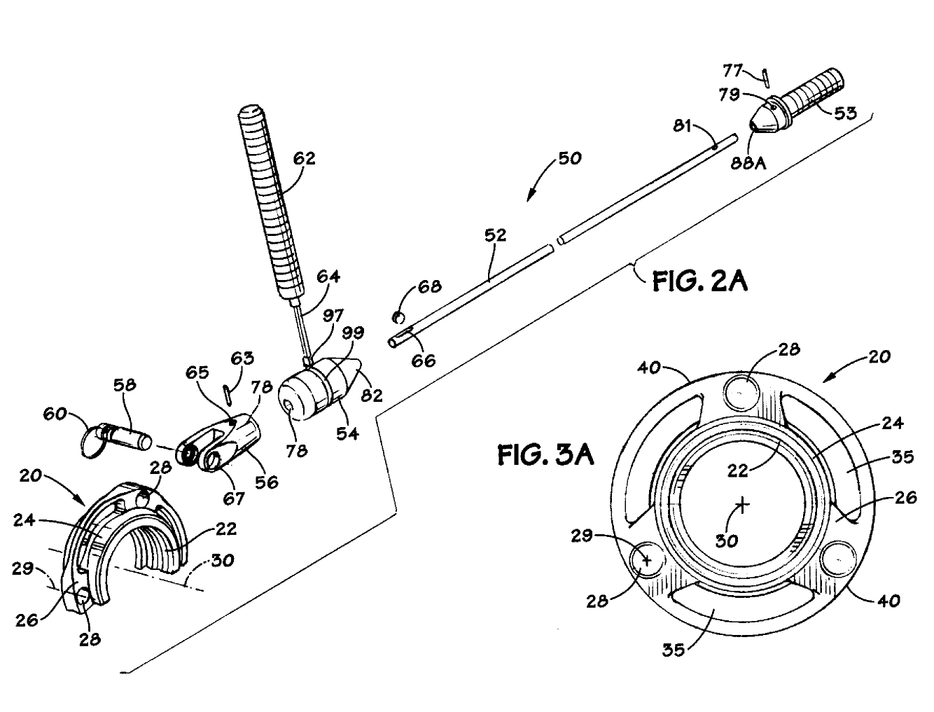

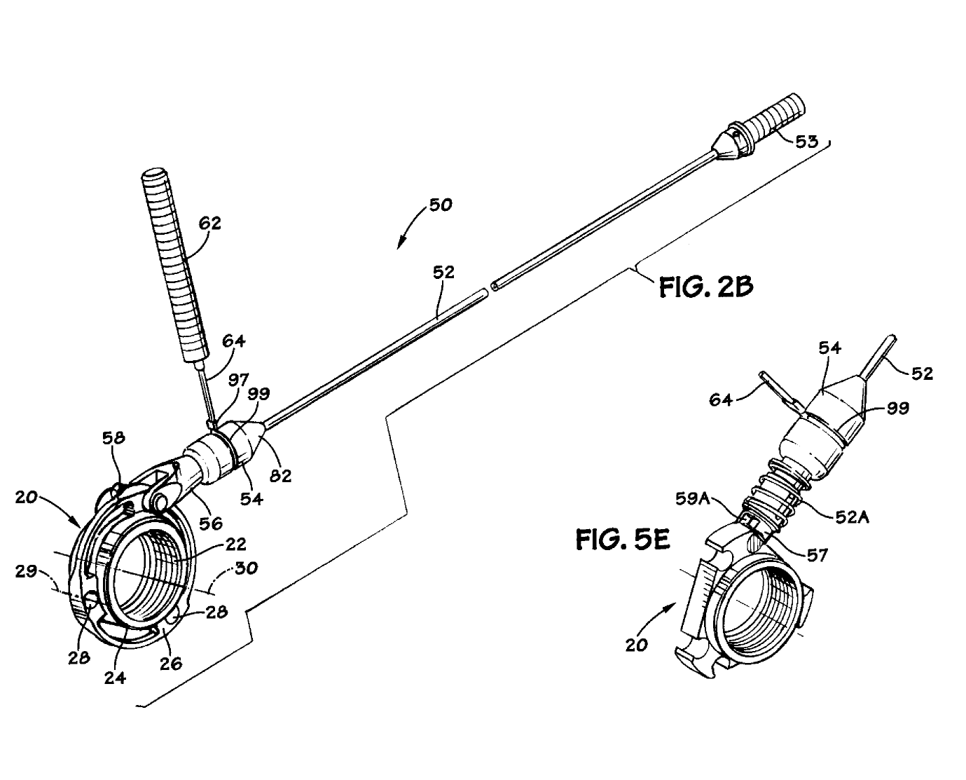

FIGS. 2A-2B are, respectively, exploded and coupled views of one illustrative embodiment of a threaded union nut 20 and an illustrative sliding hammer 50 in accordance with various aspects of the present invention. In the depicted embodiment, the threaded union nut 20 comprises a threaded opening 22, a generally circular body portion 24, webbing 26 and a plurality of impact openings 28 that are radially offset from the centerline 30 of the threaded opening 22. In the depicted embodiment, the sliding hammer 50 comprises a guide rod 52, an end handle 53, a hammer 54, a yoke 56, an impact pin 58, a quick release ring 60, a swing handle 62 and a cable 64 coupling the swing handle 62 to the hammer 54. The end handle 53 is adapted to be secured to the guide rod 52 by a pin 77 that is positioned through openings 79 in the end handle 53 and an opening 81 in the guide rod 52.

The yoke 56, a structural member, is adapted to be coupled to one of the impact openings 28 via the impact pin 58. The particular size and shape of the yoke or structural member 56 may vary depending on the particular application. The yoke 56 or structural member need not have the general clevis joint configuration depicted in the illustrative embodiment disclosed herein. In general, the sliding hammer 50 will be employed to deliver an impact blow, via hammer 54, yoke 56 and impact pin 58 to cause the threaded union nut 20 to rotate to thereby tighten or loosen the threaded union nut 20, depending upon the direction of rotation of the threaded union nut 20. Additional details of operation of the device will be described later in the application.

The size, shape and configuration of the various components of the sliding hammer 50, as well as the materials of construction, may vary depending upon the particular application. In one illustrative embodiment, the metallic parts of the sliding hammer 50 may be made of a stainless steel material. The hammer 54 may be of any desired shape or weight. In one illustrative embodiment, the hammer 54 may weigh approximately 6-10 pounds. Similarly, the guide rod 52 may have an axial length of approximately 5-8 feet and a diameter of approximately ⅜-¾ inch. The impact pin 58 may have a diameter of approximately 1-1.5 inches and an axial length of approximately 2-5 inches.

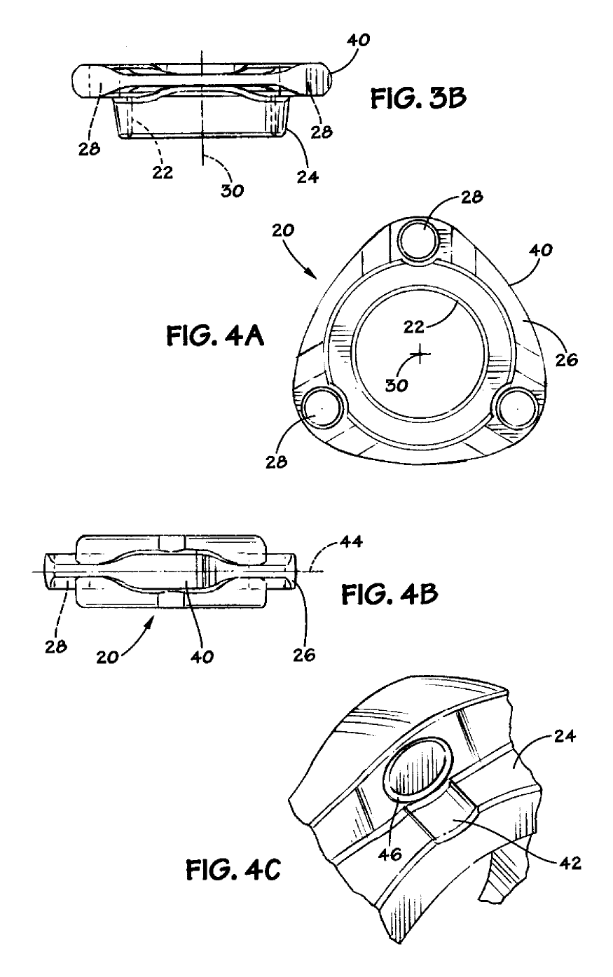

FIGS. 3A-3B depict one illustrative embodiment of the threaded union nut 20 in accordance with various aspects of the present invention. The size and configuration of the threaded union nut 20 as well as the materials of construction may vary depending upon the particular application. For example, the threaded union nut 20 may be made of carbon steel, alloy steel or stainless steel materials. In the depicted embodiment, there are three illustrative impact openings 28 that are adapted to receive the impact load generated by the hammer 54 (as it strikes the yoke 56 and is transferred by the impact pin 58) to thereby cause rotation of the threaded union nut 20. In one particularly illustrative embodiment, the impact openings 28 have a circular cross-section and have a diameter ranging from approximately 1-1.5 inches, and, in a particularly illustrative example, the diameter may be approximately 1 3/16 inches. Of course, the size, number, shape and location of the impact openings 28 may vary depending upon the particular application. Additionally, the impact openings 28 may be fully enclosed (as depicted in FIGS. 3A-3B) or they may be partially open. In one particularly illustrative embodiment, the centerline 29 of the impact openings 28 may be substantially parallel to the centerline 30 of the threaded opening 22 of the threaded union nut 20. In another particularly illustrative example, the centerline 29 may be approximately perpendicular to the helix angle of the threads of the threaded opening 22.

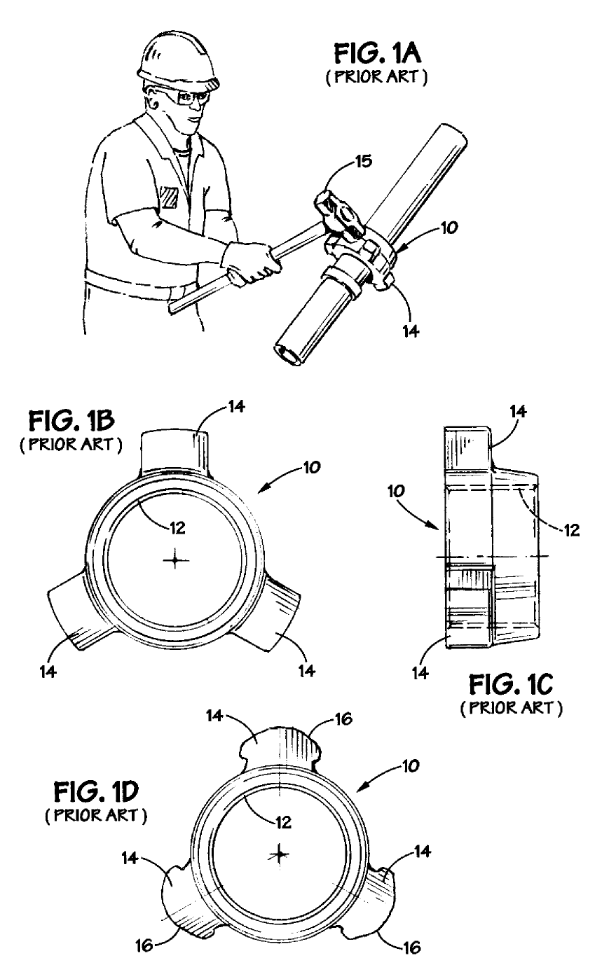

As thus configured, the threaded union nut 20 defines a perimeter 40 that is free of projections that might accommodate a hammer strike, e.g., radially extending projections such as the lugs 14 depicted in FIGS. 1A-D. By providing such a projection-free perimeter, personnel will be discouraged from attempting to rotate the threaded union nut 20 by hammer strikes, as there are no projections to strike. If desired, the threaded union nut 20 may be provided with a plurality of slots 35 in the web 26 so as to reduce the overall weight of the threaded union nut 20.

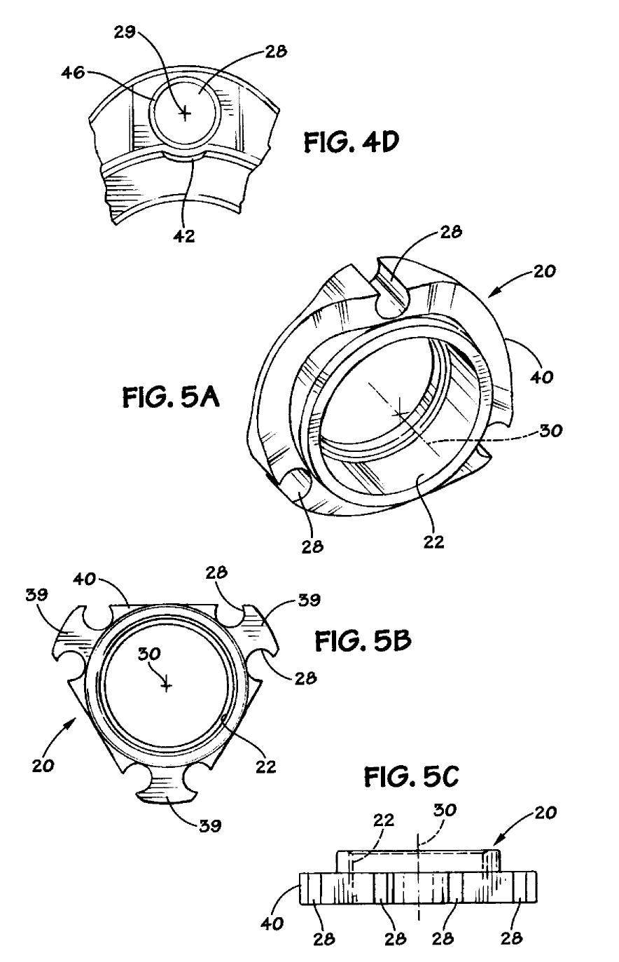

FIGS. 4A-4D depict another illustrative embodiment of a threaded union nut 20 in accordance with the present invention. In this particular embodiment, the perimeter 40 of the threaded union nut 20 has a somewhat rounded, triangular shape. However, the perimeter 40 of the threaded union nut 20 shown in FIGS. 4A-4D still does not provide a projection that may be readily struck by a hammer or other similar object. Also depicted in FIGS. 4A-4D are a plurality of recess regions 42 that are provided to assist in guiding the yoke 56 into position and to provide clearance for rotational movement of the end of the yoke 56 shown in FIGS. 2A-2B. More specifically, the end of the yoke 56 may approximately register with the recess 42 in a position such that the opening 67 in the yoke 56 is approximately aligned with the impact opening 28.

Also note that, in the illustrative threaded union nut 20 depicted in FIGS. 4A-4D, the web 26 and impact openings 28 are located at the approximate midpoint 44 of the axial length of the threaded union nut 20. With the impact openings 28 being in this position, the torque and loads generated by the impact of the hammer 54 is applied to the approximate axial midpoint 44 of the threaded union nut 20 to thereby ensure more uniform distribution of the forces involved in tightening or loosening the threaded union nut 20. Locating the web 26 at the approximate midpoint 44 also increases the overall strength of the threaded union nut 20 that is subject to fatigue loading under operating conditions.

The threaded union nut 20 may also be provided with a forged recess or tapered lead-in region 46 to provide a tapered lead-in to the impact openings 28. This tapered lead-in region 46 facilitates insertion of the impact pin 58 into the impact opening 28. As depicted in FIG. 4C, the tapered region 46 may be formed as part of the forging process that defines the basic body 24 of the threaded union nut 20. Thereafter, the impact openings 28 may be defined by a standard drilling process. Alternatively, both the impact opening 28 and the tapered region 46 may be formed by traditional machining operations. The clearance between the impact pin 58 and the impact opening 28 may vary depending upon the particular application. In one illustrative embodiment, the clearance may be approximately 0.020 inches.

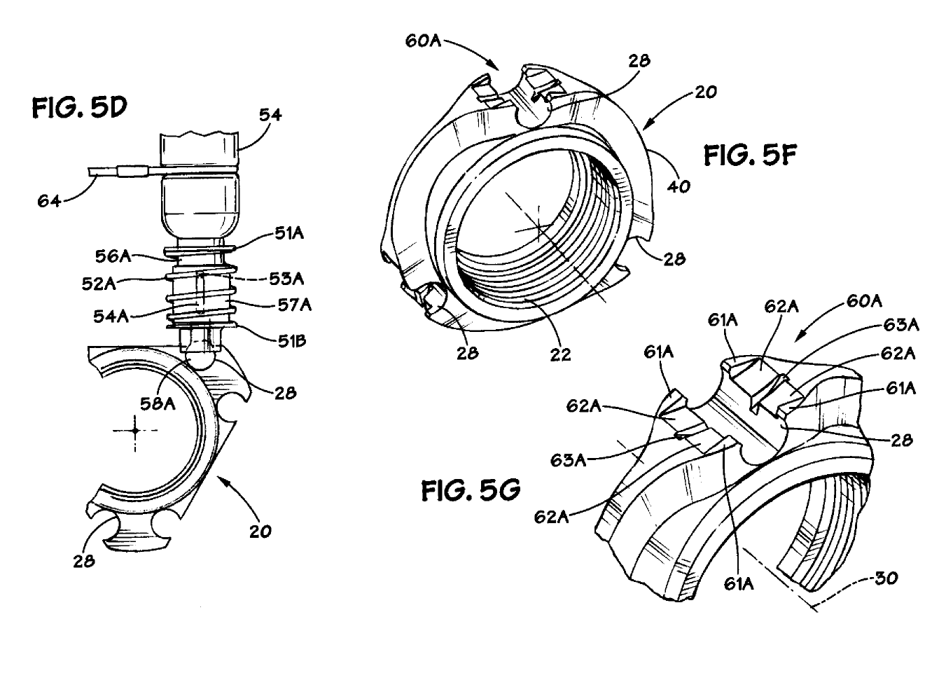

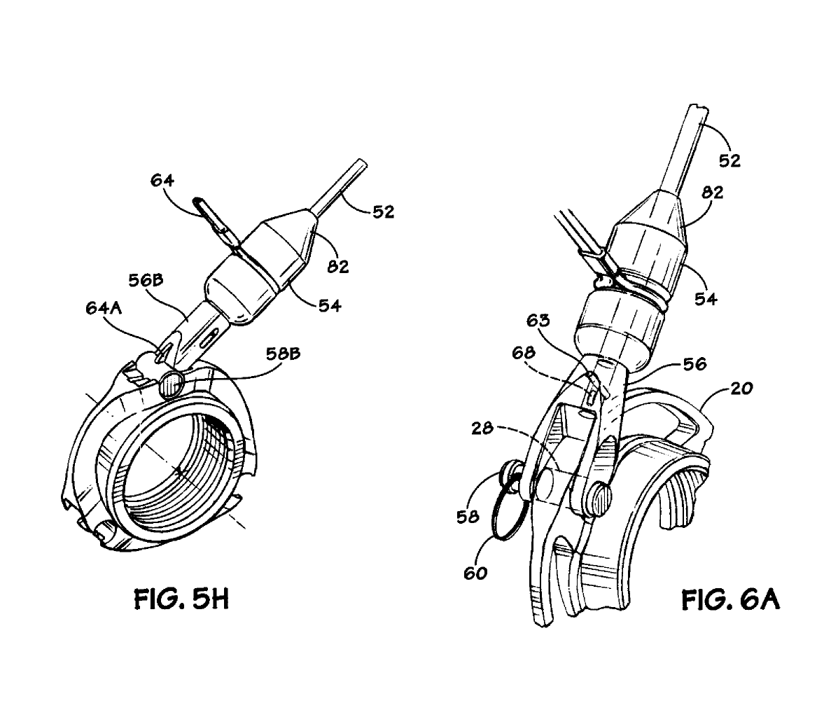

FIGS. 5A-5H depict other illustrative embodiments of the threaded union nut 20 of the present invention wherein the impact openings 28 are not completely closed. In the illustrative embodiment depicted in FIG. 5A, the perimeter 40 of this illustrative threaded union nut 20 is also free of any projections that may be struck by a hammer 15. The open impact openings 28 in this embodiment of the threaded union nut 20 may make insertion of the impact pin 58 easier to accomplish.

FIGS. 5B-5D depict yet another illustrative embodiment of a threaded union nut 20 in accordance with the present invention. In this illustrative example, the threaded union nut 20 is provided with six open impact openings 28. Three of the impact openings 28 may be used to rotate the threaded union nut 20 clockwise, while the other three impact openings 28 may be used to rotate the threaded union nut 20 in a counter-clockwise direction. However, the perimeter 40 of the illustrative threaded union nut 20 shown in FIGS. 5B-5E is not free of projections that may be struck with a hammer 15. For example, the portions 39 of the body of the threaded union nut 20 that are adjacent the pair of impact openings 28 may define a surface that could be struck with a hammer even if workers are cautioned or warned not do so. As shown in FIG. 5D, a modified yoke 56A is employed with the threaded union nut 20 depicted in FIGS. 5B-5C. The yoke 56A comprises a flange or shoulder 51A. A sleeve 57A, with a flange or shoulder 51B, is positioned around the yoke 56A. A spring 52A is positioned between the flanges 51A and 51B. A pin 53A is positioned in the body of the yoke 56A and slidingly engages a slot 54A formed in the sleeve 57A. The body of the yoke 56A is provided with an integrally formed impact pin 58A at the end of the yoke 56A. The sleeve 57A has an end slot 59A (see FIG. 5E) formed in the end of the sleeve 57A that is positioned over a portion of the threaded union nut 20 and the impact pin 58A, as shown in FIGS. 5D-5E. The spring 52A urges the sleeve 57A and flange 51B forward. The interaction between the end slot 59A and the threaded union nut 20 prevents rotation of the sleeve 57A and insures that the pin 58A remains engaged with the impact opening 28.

FIGS. 5F-5H depict yet another illustrative embodiment of a threaded union nut 20 in accordance with the present invention. In this illustrative embodiment, the threaded union nut 20 is provided with three open impact openings 28. The perimeter 40 is free of any projections that might be struck by a hammer 15. In this particular example, an engagement recess 60A is provided adjacent each of the impact openings 28. The engagement recess 60A is defined by a plurality of sidewalls 61A and generally flat surfaces 62A. Grooves 63A are also formed in the recess 60A. The recesses 60A are adapted to engage cooperating structure formed on the yoke 56B shown in FIG. 5H. More specifically, the yoke 56B comprises an integrally formed impact pin 58B that is adapted to engage the impact openings 28. The yoke 56B further comprises projections 64A that are adapted to cooperatively engage the grooves 63A formed in the recess 60A. The engagement of the groove 63A with the projections 64A and the engagement of the yoke 56B with the sidewalls 61A of the recess 60A insures proper alignment of the hammer 50 with the threaded union nut 20 and prevents the sliding hammer 50 from sliding out of the recess 60A during use.

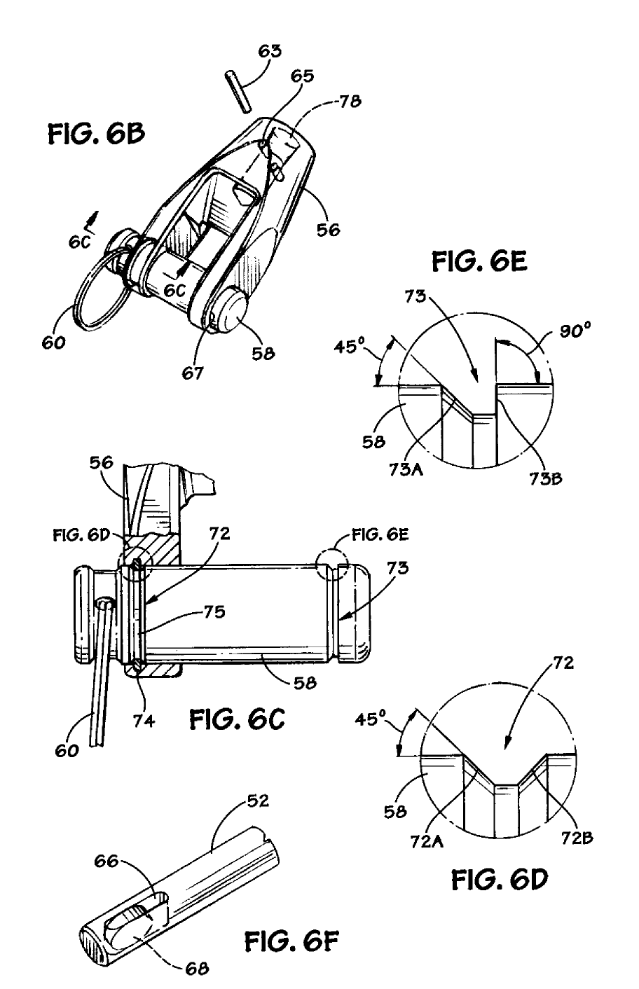

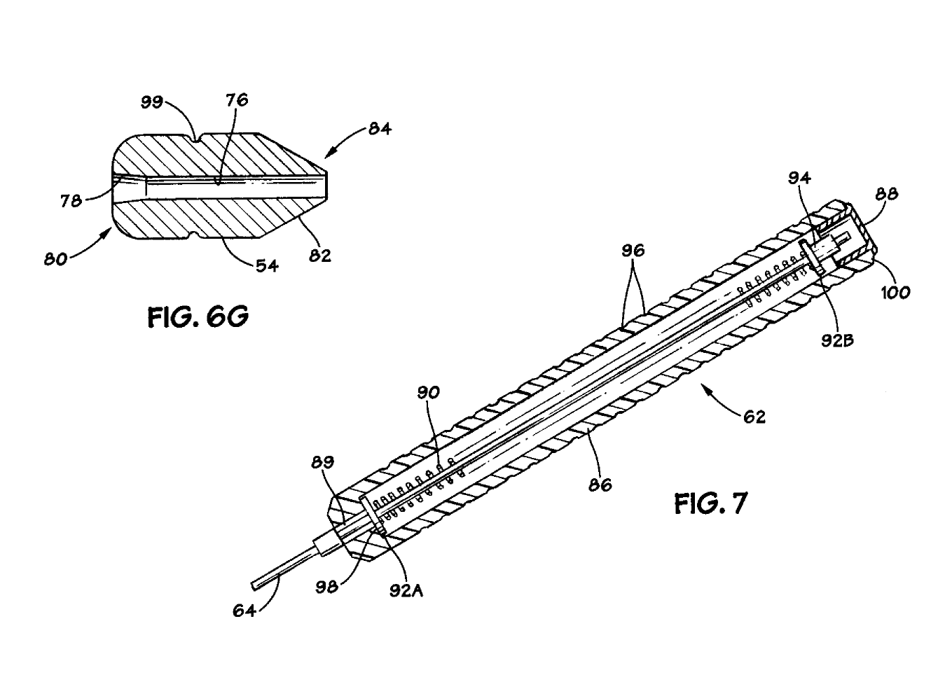

FIGS. 6A-6G and FIG. 2A depict various details regarding the hammer 54, the yoke 56 and the impact pin 58. As indicated in these drawings, the yoke 56 is secured to the guide rod 52 by a retainer pin 63 that is positioned through openings 65 in the yoke 56 and through a slotted opening 66 formed in the lower end of the guide rod 52. A dampener device 68 is provided in the bottom of the slotted opening 66 to dampen or reduce the impact loads on the retainer pin 63 during use. In one illustrative embodiment, the dampener device 68 is an elastic material that is positioned in the void in the slot 66 that is not occupied by the retainer pin 63.

The impact pin 58 is positioned through openings 67 formed in the yoke 56 and through one of the impact openings 28 in the threaded union nut 20. As shown in FIGS. 6C-6E, the impact pin 58 is provided with grooves 72 and 73, wherein the groove 72 is closer to the ring 60. The yoke 56 is provided with a recess 74 formed in one of the openings 67. An inwardly-biased retaining spring 75 is provided to cooperatively engage the groove 72 on the pin 58 and the recess 74 formed in the opening 67. The first groove 72 has sidewalls 72A, 72B that are formed at an angle, e.g., 45 degrees, to facilitate the engagement/disengagement of the retaining spring 75 with the groove 72 as the impact pin 58 is engaged or disengaged with the impact opening 28. The second groove 73 is provided with a first angled sidewall 73A, e.g., 45 degrees, and a second sidewall 73B that is approximately vertical, e.g., 90 degrees. The purpose of this arrangement is to insure that the impact pin 58 will always remain with the yoke 56 and not be removed and lost during use of the device.

In operation, the impact pin 58 may be in its retracted position wherein the retaining spring 75 is engaged with the second groove 73. The substantially vertical sidewall 73B prevents the impact pin 58 from becoming completely disengaged from the yoke 56. When it is desired to insert the impact pin 58 into an impact opening 28, a worker urges the pin 58 inward. The tapered sidewall 73A of the groove 73 permits this to be accomplished with moderate force. Insertion of the pin 58 continues until such time as the inwardly-biased retaining spring 75 is aligned with the groove 72 in the pin 58. At that time, the spring 75 engages the groove 72. The sloped sidewalls 72A, 72B of the groove 72 facilitate the engagement and disengagement of the spring 75 with the groove 72. When it is desired to remove the pin 58 from the engaged position with an impact opening, a worker pulls on the pull ring 60. The tapered sidewall 72B permits the disengagement between the spring 75 and the groove 72. Withdrawal of the pin 58 is continued until the spring 75 meets the tapered sidewall 73A at which time it engages the groove 73. Complete removal of the pin 58 is prevented by the interaction between the vertical sidewall 73B and the spring 75.

In the illustrative embodiment depicted herein, the bores of both the hammer 54 and the yoke 56 are provided with a recess 78 at the ends where contact will be made between the hammer 54 and the yoke 56. See FIGS. 2A, 6B, 6G and 8B. The recess 78 may take any form, e.g., a tapered recess, a countersink recess, etc. Of course, the recesses 78 need not be provided on both components in all applications. The purpose of the recesses 78 is to reduce or eliminate the negative impact of the bores of the hammer 54 and yoke 56 proximate the impact area becoming disfigured or distorted in this area. Absent the recesses 78, disfigurement of the bore opening of the hammer 54 and/or yoke 56 could lead to binding or galling with the guide rode 52. In the illustrative embodiment disclosed herein, the recesses 78 are depicted as tapered recess regions. As indicated in FIG. 6G, at the upper end 84 of the hammer 54, the outer surface 82 of the hammer is tapered to reduce or eliminate any tendency of the upper end 84 of the hammer 54 to pinch the fingers, skin on the palm of the hand or glove of a person between the hammer 54 and the end 88A (see FIG. 2A) of the end handle 53. The tapered outer surface 82 tends to push the fingers and palm of the hand outward as the hammer 54 moves on the guide rod 52. The clearance between the inner bore 76 and the guide rod 52 may be approximately 0.010-0.050 inches to assist in the free movement and the non-pinching function of the hammer 54.

FIG. 7 is a cross-sectional view of an illustrative swing handle 62 in accordance with one illustrative embodiment of the present invention. The swing handle 62 comprises a plastic body 86, an end cap 88, a spring 90, a plurality of washers 92A, 92B and a wire crimp 94. A plurality of friction grooves 96 are formed in the outer surface of the body 86.

To assemble the swing handle 62, the end cap 88 is removed, the cable 64 is inserted through the opening 89 in the body 86 and extended outwardly beyond the end 100 of the body 86. The cable 64 is fed through the washer 92A, through the spring 90, through the washer 92B and through the crimp 94. The crimp 94 is then secured to the cable 64 by crimping. The assembly is then pulled back within the body 86 until such time as the washer 92A strikes the shoulder 98 of the body 86. The end cap 88 is then snapped into engagement with the body 86.

The various components of the swing handle 62 may be made in any desired shape or configuration and they may be made of any desired material. For example, the spring 90 may be a coil-type spring having a spring constant of approximately 2-4 lbs/in. In one illustrative embodiment, the spring is preloaded to the approximate weight of the hammer 54. The purpose of the spring preload is to use the stored energy in the spring 90 to accelerate the hammer 54 as it is swung. The cable 64 may be a solid or wire rope type cable. The cable 64 may be made of stainless steel, e.g., wire rope, it may have a diameter of approximately ⅛-¼ inches, and it may have a length (from the hammer 54 to the handle 62) of approximately 2-3 feet. Of course, such details may vary depending upon the particular application. In the depicted embodiment, the hammer 54 is provided with an exterior groove 99 that is adapted to have the cable 64 positioned therein. In one particular embodiment, the cable 64 may be positioned in the groove 99 and a crimp 97 may be used to secure the cable 64 to itself and thereby lock in the cable 64 within the groove 99 of the hammer 54. This double cable configuration may be extended through the spring 90 within the swing handle 62 or a single cable may extend through the spring 90.

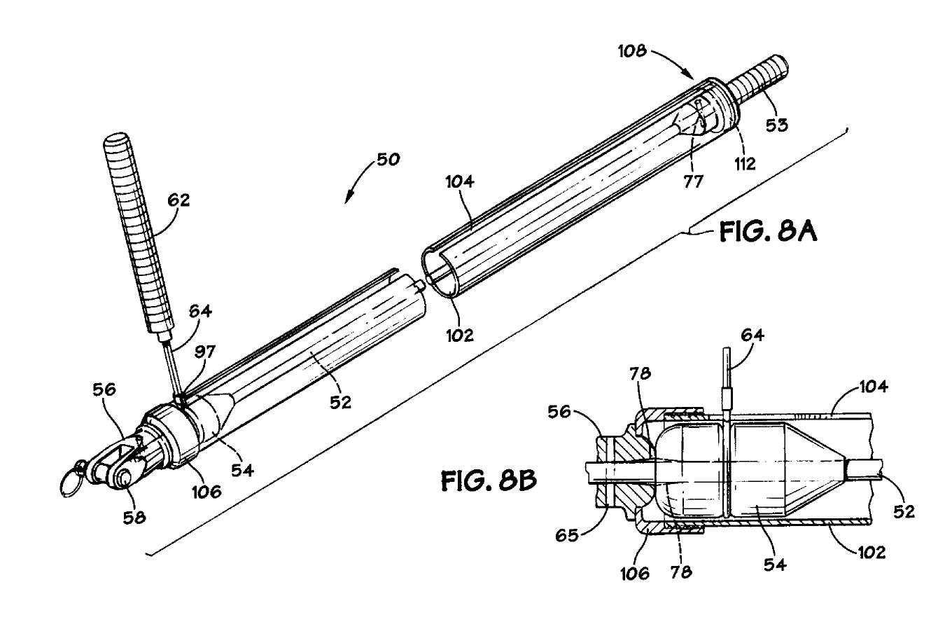

FIGS. 8A-8C depict an illustrative embodiment wherein the hammer 50 is provided with an outer protective cover 102. The protective cover 102 has a slot 104 defined therein to allow movement of the cable 64. The lower end of the protective cover 102 comprises a cap 106 that rests on the upper portion of the yoke 56. See FIG. 8B. The upper end 108 of the protective cover 102 may be secured to the guide rod 52 by a handle 53 with a threaded portion 112 that is adapted to threadingly engage internal threads (not shown) formed on the interior of the protective cover 102. See FIG. 8C.

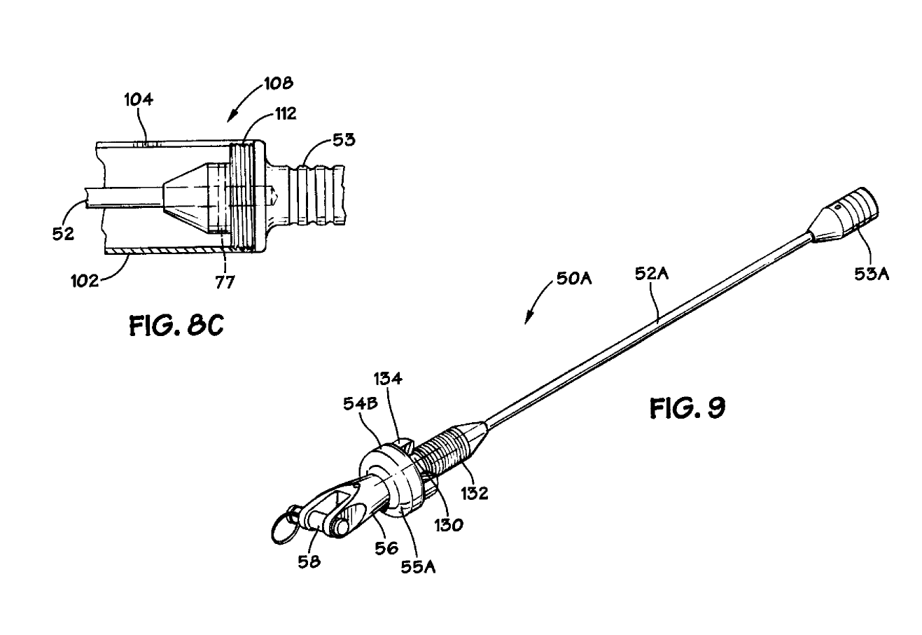

FIG. 9 depicts an alternative embodiment of a sliding hammer 50A that may be employed with the present invention. The sliding hammer device 50A depicted in FIG. 9 is generally smaller in size than the one depicted in FIGS. 2A-2B, e.g., the rod 52A may have a length of approximately 2-4 feet. In the depicted embodiment, the sliding hammer device 50A does not have cable 64 and swing handle 62. The sliding hammer device 50A depicted in FIG. 9 may be operated with one hand and may be employed in places where access is very limited. In this illustrative embodiment, the hammer 54B comprises an enlarged or bell-shaped end 55A, a section of padding 134, and a handle 132 within a roughened outer surface. The size of the enlarged bell-shaped end 55A should be large enough to prevent the user's hand from sliding off of the hammer 54B and to discourage a user from positioning his/her hand between the hammer 54B and the yoke or structural member 56. The opposite end of the rod 52A has a relatively short handle 53A. After connecting the impact pin 58 to the impact opening 28, a person may simply grasp the handle 132 of the hammer 54B and strike the yoke 56 to rotate the threaded union nut 20. The padding 134 is present to prevent any damage to the worker's hand during use. The padding 134 may take any form, e.g., it may be any type of padding material surrounded by a waterproof material for weather protection.

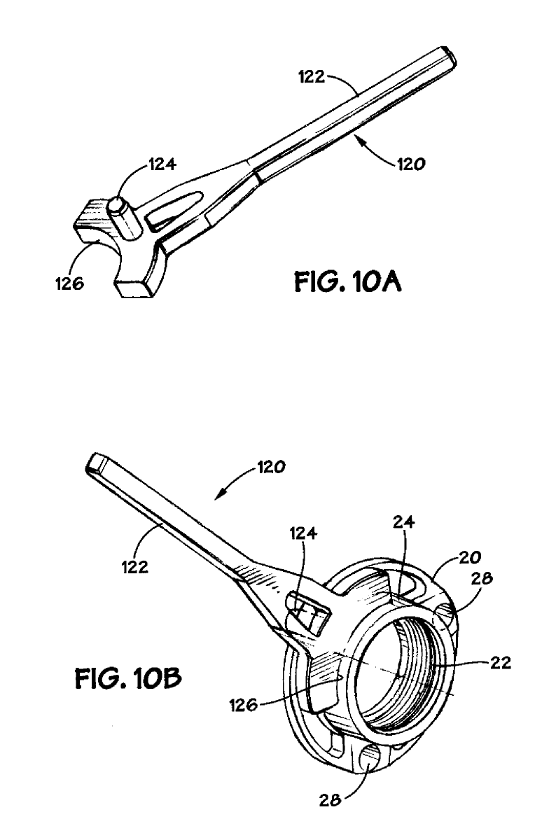

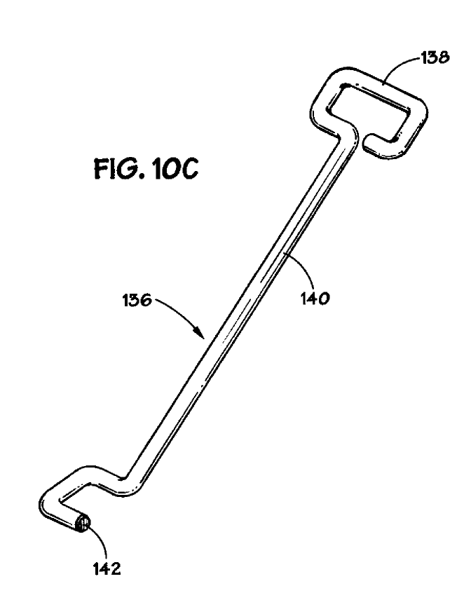

FIGS. 10A-10C depict illustrative tools 120 and 136 that may be employed to rotate the threaded union nut 20 until such time as it is necessary to employ the sliding hammer 50 to finish tightening the threaded union nut 20. Alternatively, the tools 120, 136 may be used after the sliding hammer 50 is employed to initially loosen the threaded union nut 20. As shown in FIGS. 2A-2B, the tool 120 comprises a handle 122 and a pin 124 that is adapted to be positioned in one of the impact openings 28 on the threaded union nut 20. The tool 120 further comprises a curved portion 126 that corresponds approximately to the outer surface of the body 24 of the threaded union nut 20. The tool 136 depicted in FIG. 10C comprises a body 140, a handle 138 and a projection 142. The projection 142 may be inserted into one of the impact openings 58.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A threaded union nut, comprising:
a body;
a threaded opening formed in said body; and
a web comprising a plurality of impact openings that are radially offset from a centerline of said threaded opening, said impact openings adapted to be engaged by a device so as to rotate said threaded union nut.

2. The device of claim 1, wherein said web defines a projection-free perimeter.

3. The device of claim 1, wherein said web defines a perimeter that is free of projections that extend radially beyond said perimeter.

4. The device of claim 1, wherein said web defines a substantially circular perimeter.

5. The device of claim 1, wherein said impact openings have a centerline that is substantially parallel to said centerline of said threaded opening.

6. The device of claim 1, wherein said impact openings have a centerline that is substantially perpendicular to a helix angle of a thread formed in said threaded opening.

7. The device of claim 1, wherein said impact openings are circular in cross-section.

8. The device of claim 1, wherein said impact openings are closed openings.

9. The device of claim 1, wherein said impact openings further comprise a tapered lead-in region.

10. The device of claim 9, wherein said tapered lead-in region is adapted to facilitate positioning of a pin in said impact openings.

11. The device of claim 1, further comprising a recess formed in said body proximate each of said impact openings.

12. The device of claim 11, wherein said recess is adapted to facilitate alignment of a device comprising a pin adjacent said opening.

13. A threaded union nut, comprising:
a body;
a threaded opening formed in said body; and
a web comprising a plurality of impact openings that are radially offset from a centerline of said threaded opening, said impact openings having a centerline that is substantially parallel to said centerline of said threaded opening, wherein said impact openings adapted to be engaged by a device so as to rotate said threaded union nut, and wherein said web defines a projection-free perimeter.

14. The device of claim 13, wherein said projection-free perimeter is free of projections that extend radially beyond said perimeter.

15. The device of claim 13, wherein said impact openings further comprise a tapered lead-in region.

16. The device of claim 15, wherein said tapered lead-in region is adapted to facilitate positioning of a pin in said impact openings.

17. The device of claim 13, further comprising a recess formed in said body proximate each of said impact openings.

18. The device of claim 17, wherein said recess is adapted to facilitate alignment of a device comprising a pin adjacent said opening.

19. A threaded union nut, comprising:
a body;
a threaded opening formed in said body;
a web comprising a plurality of impact openings that are radially offset from a centerline of said threaded opening, wherein said impact openings further comprise a tapered lead-in region, wherein said impact openings are adapted to be engaged by a pin that is to be positioned in said openings so as to rotate said threaded union nut; and
a recess formed in said body proximate each of said impact openings, wherein said recess is adapted to facilitate alignment of a device comprising a pin adjacent said opening.

20. The device of claim 19, wherein said web defines a projection-free perimeter.

21. The device of claim 19, wherein said web defines a perimeter that is free of projections that extend radially beyond said perimeter.

22. The device of claim 19, wherein said web defines a substantially circular perimeter.

23. The device of claim 19, wherein said impact openings have a centerline that is substantially parallel to said centerline of said threaded opening.

24. The device of claim 19, wherein said impact openings have a centerline that is substantially perpendicular to a helix angle of a thread formed in said threaded opening.

25. A device, comprising:
a guide rod;
a structural member coupled to said guide rod;
a hammer having an internal bore adapted to receive said guide rod therein, said hammer being adapted to transfer an impact load to said structural member;
a flexible cable; and
a swing handle, wherein said cable is coupled to said hammer and to said swing handle.

26. The device of claim 25, wherein said hammer is adapted to strike said structural member.

27. The device of claim 25, further comprising an impact pin adapted to be positioned in openings formed in said structural member.

28. The device of claim 25, wherein said structural member is a yoke.

29. The device of claim 25, wherein said structural member comprises a clevis joint.

30. The device of claim 25, wherein said internal bore of said hammer comprises a recess at an end of said hammer proximate said structural member.

31. The device of claim 30, wherein said recess comprises at least one of a tapered region or a countersink region.

32. The device of claim 25, wherein said structural member comprises an internal bore adapted to receive said guide rod therein, and wherein said internal bore of said structural member comprises a recess at an end of said structure member proximate said hammer.

33. The device of claim 32, wherein said recess comprises at least one of a tapered region or a countersink region.

34. The device of claim 25, wherein said cable is slidingly coupled to said swing handle.

35. The device of claim 25, wherein said cable is coupled to said swing handle by a mechanism that comprises a spring.

36. The device of claim 25, further comprising a protective cover positioned around said guide rod, said protective cover comprising a slot that is adapted to allow said cable to move within said slot.

37. The device of claim 25, wherein said structural member is coupled to said guide rod by a shock dampening device.

38. The device of claim 37, wherein said shock dampening device comprises an elastic material.

39. The device of claim 25, wherein said structural member is coupled to said guide rod by a pin that is positioned in an opening formed in said guide rod.

40. The device of claim 39, further comprising an elastic material positioned in said opening in said guide rod.

41. The device of claim 25, wherein said hammer comprises a first end proximate said structural member and a second end remote from said structural member, said hammer further comprising a tapered outer surface proximate said second end of said hammer.

42. The device of claim 41, wherein said tapered outer surface tapers outwardly from said second end of said hammer.

43. The device of claim 41, wherein said tapered outer surface has a smaller outer diameter proximate said second end of said hammer as compared to a diameter of said tapered outer surface remote from said second end of said hammer.

44. The device of claim 41, wherein said tapered outer surface is adapted to urge a body part of a user away from said guide rod as said user grasps said hammer during use to reduce the likelihood of pinching said body part.

45. A device, comprising:
a guide rod;
a structural member coupled to said guide rod by a shock dampening device;
a hammer having an internal bore adapted to receive said guide rod therein, said hammer being adapted to strike said structural member;
a flexible cable; and
a swing handle, wherein said cable is coupled to said hammer and to said swing handle.

46. The device of claim 45, further comprising an impact pin adapted to be positioned in openings formed in said structural member.

47. The device of claim 45, wherein said structural member is a yoke.

48. The device of claim 45, wherein said structural member comprises a clevis joint.

49. The device of claim 45, wherein said cable is slidingly coupled to said swing handle.

50. The device of claim 45, wherein said cable is coupled to said swing handle by a mechanism that comprises a spring.

51. The device of claim 45, further comprising a protective cover positioned around said guide rod, said protective cover comprising a slot that is adapted to allow said cable to move within said slot.

52. The device of claim 45, wherein said shock dampening device comprises an elastic material.

53. The device of claim 45, wherein said internal bore of said hammer comprises a recess at an end of said hammer proximate said structural member.

54. The device of claim 53, wherein said recess comprises at least one of a tapered region or a countersink region.

55. The device of claim 45, wherein said structural member comprises an internal bore adapted to receive said guide rod therein, and wherein said internal bore of said structural member comprises a recess at an end of said structure member proximate said hammer.

56. The device of claim 55, wherein said recess comprises at least one of a tapered region or a countersink region.

57. The device of claim 45, wherein said hammer comprises a first end proximate said structural member and a second end remote from said structural member, said hammer further comprising a tapered outer surface proximate said second end of said hammer.

58. The device of claim 57, wherein said tapered outer surface tapers outwardly from said second end of said hammer.

59. The device of claim 57, wherein said tapered outer surface has a smaller outer diameter proximate said second end of said hammer as compared to a diameter of said tapered outer surface remote from said second end of said hammer.

60. The device of claim 57, wherein said tapered outer surface is adapted to urge a body part of a user away from said guide rod as said user grasps said hammer during use to reduce the likelihood of pinching said body part.

61. A device, comprising:
a guide rod;
a structural member coupled to said guide rod by a shock dampening device, said structural member comprising an internal bore adapted to receive said guide rod therein;
a hammer having an internal bore adapted to receive said guide rod therein, said hammer being adapted to strike said structural member, wherein said internal bore of said hammer comprises a recess at an end of said hammer proximate said structural member, and wherein said internal bore of said structural member comprises a recess at an end of said structure member proximate said hammer;
a flexible cable; and
a swing handle, wherein said cable is coupled to said hammer and to said swing handle.

62. The device of claim 61, further comprising an impact pin adapted to be positioned in openings formed in said structural member.

63. The device of claim 61, wherein said structural member is a yoke.

64. The device of claim 61, wherein said structural member comprises a clevis joint.

65. The device of claim 61, wherein said cable is slidingly coupled to said swing handle.

66. The device of claim 61, wherein said cable is coupled to said swing handle by a mechanism that comprises a spring.

67. The device of claim 61, further comprising a protective cover positioned around said guide rod, said protective cover comprising a slot that is adapted to allow said cable to move within said slot.

68. The device of claim 61, wherein said shock dampening device comprises an elastic material.

69. The device of claim 61, wherein said recess in said bore of said hammer comprises at least one of a tapered region or a countersink region.

70. The device of claim 61, wherein said recess in said bore of said structural member comprises at least one of a tapered region or a countersink region.

71. The device of claim 61, wherein said hammer comprises a first end proximate said structural member and a second end remote from said structural member, said hammer further comprising a tapered outer surface proximate said second end of said hammer.

72. The device of claim 71, wherein said tapered outer surface tapers outwardly from said second end of said hammer.

73. The device of claim 71, wherein said tapered outer surface has a smaller outer diameter proximate said second end of said hammer as compared to a diameter of said tapered outer surface remote from said second end of said hammer.

74. The device of claim 71, wherein said tapered outer surface is adapted to urge a body part of a user away from said guide rod as said user grasps said hammer during use to reduce the likelihood of pinching said body part.

75. A device, comprising:
a guide rod;
a structural member coupled to said guide rod; and
a hammer having an internal bore adapted to receive said guide rod therein, said hammer being adapted to transfer an impact load to said structural member, wherein said hammer comprises a first end proximate said structural member and a second end remote from said structural member, said hammer further comprising a tapered outer surface proximate said second end of said hammer.

76. The device of claim 75, wherein said hammer is adapted to strike said structural member.

77. The device of claim 75, wherein said structural member is a yoke.

78. The device of claim 75, wherein said structural member comprises a clevis joint.

79. The device of claim 75, wherein said internal bore of said hammer comprises a recess at an end of said hammer proximate said structural member.

80. The device of claim 79, wherein said recess comprises at least one of a tapered region or a countersink region.

81. The device of claim 75, wherein said structural member comprises an internal bore adapted to receive said guide rod therein, and wherein said internal bore of said structural member comprises a recess at an end of said structural member proximate said hammer.

82. The device of claim 81, wherein said recess comprises at least one of a tapered region or a countersink region.

83. The device of claim 75, wherein said structural member is coupled to said guide rod by a shock dampening device.

84. The device of claim 83, wherein said shock dampening device comprises an elastic material.

85. The device of claim 75, wherein said structural member is coupled to said guide rod by a pin that is positioned in an opening formed in said guide rod.

86. The device of claim 85, further comprising an elastic material positioned in said opening in said guide rod.

87. The device of claim 75, wherein said tapered outer surface tapers outwardly from said second end of said hammer.

88. The device of claim 75, wherein said tapered outer surface has a smaller outer diameter proximate said second end of said hammer as compared to a diameter of said tapered outer surface remote from said second end of said hammer.

89. The device of claim 75, wherein said tapered outer surface is adapted to urge a body part of a user away from said guide rod as said user grasps said hammer during use to reduce the likelihood of pinching said body part.
